(19) United States
(12) Patent Application Publication
(10) Pub. No.: US 2019/0095357 A1
(43) Pub. Date: Mar. 28, 2019

(54) HARDWARE SUPPORT FOR STATIC MODE OF PROTECTED MEMORY MANAGEMENT ON FLEXIBLY-CONVERTIBLE ENCLAVE PLATFORM

(71) Applicant: Intel Corporation, Santa Clara, CA (US)

(72) Inventors: Meltem OZSOY, Portland, OR (US); Vedvyas SHANBHOGUE, Austin, TX (US); Krystof C. ZMUDZINSKI, Forest Grove, OR (US); Francis X. MCKEEN, Portland, OR (US); Carlos V. ROZAS, Portland, OR (US); Ilya ALEXANDROVICH, Haifa (IL); Ittai ANATI, Haifa (IL); Raghunandan MAKARAM, Northborough, MA (US); Dror CASPI, Kiryat Yam (IL); Hisham SHAFI, Akko (IL)

(21) Appl. No.: 15/719,222

(22) Filed: Sep. 28, 2017

(51) Int. Cl. G06F 12/14; G06F 9/44

(52) U.S. Cl. CPC G06F 12/1441; G06F 2212/1052; G06F 12/1466; G06F 9/4401

(57) ABSTRACT

A system includes a processor core and main memory. The processor core is to, in response to execution of a patch-load instruction, retrieve, from a predetermined area of the main memory, memory protection metadata and a memory range of reserved memory, wherein the reserved memory is not flexibly convertible to enclave pages. The processor core is further to retrieve a bit from an architectural control register, wherein a value of the bit is to indicate whether an operating system is capable of management of flexibly-convertible enclave pages. The processor core is further to activate, using the memory protection metadata and one of the first information or the second information, a mode of protected memory management for the processor core in response to the value of the bit in the architectural control register.

### TECHNICAL FIELD

The disclosure relates to protection of data stored in memory of a computer system, and more particularly, to support of static mode in protected memory on a flexibly-convertible enclave computer system.

### BACKGROUND

Modern processors are designed to protect sensitive data in memory from both hardware and software attacks, and regions of memory so protected are referred to herein as protected memory. Some processors provide cryptographic mechanisms for encryption, integrity, and replay protection. Memory encryption protects the confidentiality of memory-resident data. On the other hand, integrity protection prevents an attacker from causing any hidden modifications to the cipher text (i.e., encrypted data, as opposed to plaintext which is unencrypted data) in memory, and replay protection eliminates any undetected temporal substitution of the cipher text. In the absence of such protections, an attacker with physical access to the system can record snapshots of data lines and replay them at a later point in time.

A static mode of protected memory management statically reserves a predetermined memory range of main memory that uses enclave pages and is the legacy mode employed by many processors. An updated mode of protected memory management allows flexible conversion of main memory as protected memory, greatly increasing the amount of memory available as protected memory, which also increases the efficiency of protected memory allocation. In order to change the mode of memory protection management, a basic input/output system (BIOS) determines which mode to employ, and communicates that mode to an operating system upon boot of the computer system. Accordingly, in order to change the mode of protected memory management after the computer system is running, the computer system is rebooted so that the BIOS can reset the mode of protected memory management for the operating system to use.

### BRIEF DESCRIPTION OF THE DRAWINGS

FIG. 1 is a block diagram illustrating a computer system that employs a memory encryption engine (MEE) for implementing protected memory operations, according to implementations of the disclosure.

FIG. 2 is block diagram of a table stored in a predetermined area of main memory accessible by both the basic input/output system (BIOS) and the operating system of the computer system, according to implementations of the disclosure.

FIG. 3 is a flow chart of method by which the operating system chooses a mode of protected memory management, and locks into that mode for operation, according to implementations of the disclosure.

FIG. 4 is a memory diagram illustrating different ranges of memory allocable for conversion to enclave pages and reserved memory that is not allocable for such conversion, according to implementations of the disclosure.

FIG. 5 is a flow chart of a method of providing hardware support for static mode and flexibly-convertible enclave mode to the operating system, without requiring a reboot, according to implementations of the disclosure.

FIG. 6A is a block diagram illustrating an in-order pipeline and a register renaming stage, out-of-order issue/execution pipeline according to one implementation.

FIG. 6B is a block diagram illustrating a micro-architecture for a processor or an integrated circuit that may that implement hardware support for static mode of protected memory management on flexibly-convertible enclave platform, according to an implementation of the disclosure.

FIG. 7 illustrates a block diagram of the micro-architecture for a processor or an integrated circuit that implements hardware support for static mode of protected memory management on flexibly-convertible enclave platform, according to an implementation of the disclosure.

FIG. 8 is a block diagram of a computer system according to one implementation.

FIG. 9 is a block diagram of a computer system according to another implementation.

FIG. 10 is a block diagram of a system-on-a-chip according to one implementation.

FIG. 11 illustrates another implementation of a block diagram for a computing system.

FIG. 12 illustrates another implementation of a block diagram for a computing system.

### DETAILED DESCRIPTION

Memory encryption protects the confidentiality of memory-resident data. Memory encryption is primarily designed to protect against passive attacks where an attacker tries to silently observe the data lines as the data lines move on and off the processor die. Some processors include an encryption module that encrypts sensitive data before the data is stored into a protected region of the memory. On a memory read to the protected region, the data line is decrypted before being fed into the processor. The encryption and decryption algorithms can be chosen based on the security level required by the user or by the software.

The disclosure describes hardware support of static mode of protected memory management on a flexibly-convertible enclave platform. In one implementation, the disclosure provides for an operating system (OS) of a computer system to choose between two modes of protected memory management. The two modes may include a static mode that uses static allocation of protected memory and a flexibly-convertible enclave mode that enables flexible allocation of protected memory to multiple memory ranges of main memory. An enclave refers to a secure container, e.g., an isolated memory region of code and data within main memory that is protected with a level of security, which includes at least encryption. The memory an enclave uses is also sometimes referred to as an enclave page cache (EPC). Furthermore, the flexibly-convertible enclave mode can be referred to as flexible EPC (or FEPC) mode. Memory that is EPC memory may be managed by system software such as the OS or a virtual machine monitor (VMM). The ability to choose between the two modes of protected memory management also enables switching between two operating systems on dual-boot (or multi-boot) platforms without user intervention (e.g., changing basic input/output system (BIOS) settings) or multiple reboots when a first OS is supported with legacy memory protection and a second OS is supported with flexibly-convertible enclave pages.

This dual-mode memory protection, available to the first OS or to both the first OS and the second OS, is made possible through a processor core of a processor executing a BIOS, which is configured to set up both modes of protected memory management from which the OS may choose (understanding that the disclosure can be extended to more than two modes of protected memory management). For example, the BIOS may write first information and second information to a predetermined area of main memory that operates like an electronic mailbox, delivering information to one or more operating systems for use in selecting between modes of protected memory management. The first information, for example, may delineate a memory range of the main memory allocable for conversion to enclave pages. The second information may delineate sub-sets of the memory range allocated for reserved memory, which is not flexibly-convertible to enclave pages.

In various implementations, the processor core may then execute a patch-load instruction (or the like instruction) to retrieve, from the predetermined area of the main memory, memory protection metadata and the memory range of reserved memory within the main memory. The patch-load instruction, in one example, may be firmware called by the BIOS during boot of the operating system that works to load a patch of data from memory during a read operation. The processor core or another processor core may execute the OS, which may write a bit to an architectural control register to indicate whether the OS is capable of management of enclave pages that are flexibly convertible within the main memory (e.g., in FEPC mode). The processor core may then access the bit and activate, using the protection metadata and the memory range, a mode of protected memory management for the processor core in response to a determination, based on a value of the bit in the architectural control register, of whether the operating system is capable of management of the enclave pages that are flexibly convertible within the main memory.

For example, if the OS is not capable of management of the enclave pages (e.g., not FEPC-capable), the processor core may detect execution of a first enclave system function associated with the static mode, and activate the static mode of memory protection for the OS to use. In static mode, the processor core may command a memory controller to allocate entries to a static range of EPC-convertible enclave pages of the main memory, e.g., via static allocation of enclave pages. Otherwise, if the OS is capable of flexible conversion of enclave pages within the main memory (e.g., is FEPC-capable), the OS may activate the flexibly-convertible enclave mode in response to detecting this capability. Because the BIOS sets up (at boot time) the capability of both the static mode and the flexibly-convertible enclave mode, the OS has the option to select one of these modes after boot. The OS may also change from one of these modes to another of these modes after a period of time, e.g., due to a switch to executing OS or software that is not capable of the flexible conversion of enclave pages within the main memory.

When operating in the flexibly-convertible enclaves (FEPC) mode, the memory range may include multiple sections of convertible pages that can be converted to secure pages or non-secure pages. Software executing on the processor can identify a page in the main memory to be converted and can use a page conversion instruction to convert the page. The processor core, in response to a page conversion instruction, can determine from the page conversion instruction the convertible page in the memory range to be converted and convert the convertible page to be a secure page or a non-secure page. It is the responsibility of system software (e.g., OS or VMM or the like) to identify a page that can be converted. For example, if the OS utilizes a non-secure page, the OS can identify a secure page (if a non-secure page is not available) and execute the page conversion instruction on this secure page.

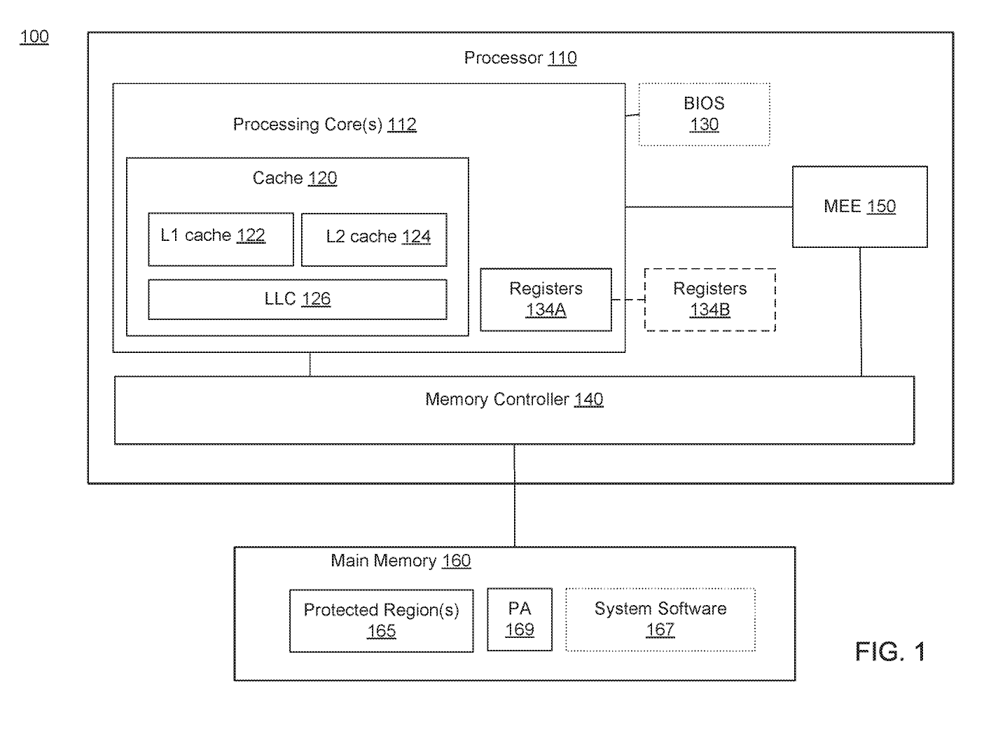

FIG. 1 is a block diagram illustrating a computer system 100 that employs a memory encryption engine (MEE) for implementing protected memory operations, according to implementations of the disclosure. The computer system 100 may include a processor 110 and main memory 160. The processor 110 may be incorporated into a processing device that is a part of the computer system 100. The processor 110 may include one or more processing core(s) 112, basic input/output system (BIOS) 130 firmware, a memory controller 140, and a MEE 150, among other components.

In various implementations, each processing core 112 may include a cache 120 and a number of registers 134A. The cache 120 may include multiple levels of cache, such as L1 cache 122, L2 cache 24, and last level cache (LLC) 126 positioned closest to the memory controller 140, although other levels of cache are envisioned. Some of the registers 134A may be implemented as registers 134B, as part of uncore hardware of the processor 110. The memory controller 140 may be coupled between the cache 120 and the main memory 160, to direct storing data to and retrieving data from the main memory 160. The memory encryption engine (MEE) 150 may be coupled to the processing core(s) 112 and the memory controller 140, and may control protection of data stored to the main memory 160.

The main memory 160 may include one or more protected regions 165, code (e.g., instructions executable by the processor 110) for system software 167, such as an operating system (OS) a virtual machine monitor (VMM), and a predetermined area 160 of the main memory 169. The OS and the VMM may be executable by one or more processor cores 112. The protected regions 165 may be designated as a range of memory addresses, which in the static mode may be a static range of memory, and in the flexibly-convertible enclave mode, may be a number of ranges to which the memory controller 140 may dynamically allocate for conversion to enclave pages.

In one implementation, the MEE 150 is located between the last level cache 126 and the memory controller 140 to perform encryption, decryption, and authentication of data lines moving in and out of the protected region(s) 165 of the main memory 160. These data lines may be associated with or accessed by system software, firmware, or an application of the system software. In one implementation, the MEE 150 is located on the processor die, while the main memory 160 is located off the processor die. According to one implementation, the MEE 150 processes multiple memory read requests in parallel to improve the access latency to the protected region 165. The MEE 150 performs counter mode encryption, which requires an encryption seed to be unique for a data line both temporally and spatially. An encryption seed may be a beginning alpha numeric (or just numeric) sequence, for example. While spatial uniqueness can be achieved by using the address of the data line to be accessed, temporal uniqueness can be achieved by using a counter that serves as the version of the data line. The MEE 150 may also protect the data lines in the protected region 165 of the main memory 160 by using a counter tree structure in which the root of the tree is stored on-die and forms the root of trust (i.e., a trust boundary). The versions of the data lines are part of this counter tree structure. Alternatively, other protection mechanisms may be used for replay-protection.

In various implementations, the predetermined area (PA) 169 of the main memory 160 may be implemented like an electronic mailbox or other container known to both the BIOS 130 and other system firmware, e.g., one or more patch-load instruction. Accordingly, when the processor core 112 executes the BIOS 130, the BIOS may know to read certain data from the PA 169 and to store other data to the PA 169 for access by the system software 167, and the patch-load instruction may know to retrieve the stored data from the PA 169. In other implementations, pointers to the data are stored in the PA 169.

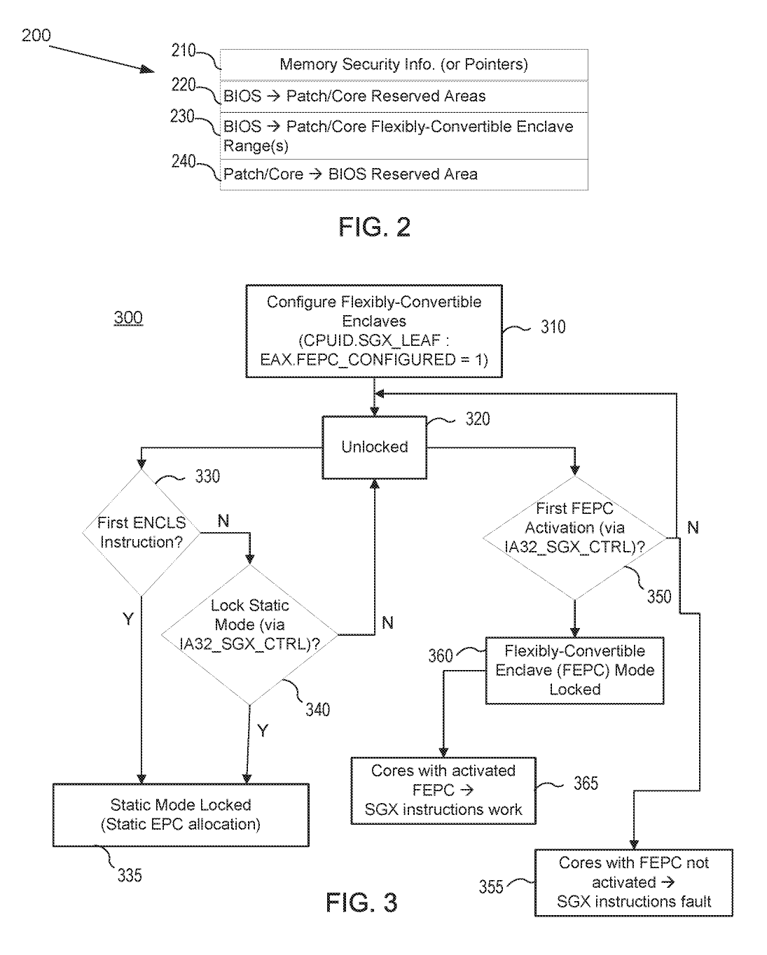

More particularly, FIG. 2 is block diagram of a table 200 stored in the predetermined area (PA) 169 of the main memory 160 accessible by both the BIOS 130 and other system firmware, which includes the patch-load instruction, according to implementations of the disclosure. In other implementations, data is passed through the PA 169 using a different data structure such as a linked list, a spreadsheet, or a database. The PA 169 may maintain memory security information 210, including the aforementioned memory protection metadata, in addition to pointers to memory addresses where specific information is stored. In the implementation of FIG. 2, the pointers may include a first pointer 220, a second pointer 230, and a third pointer 240, although other pointers are envisioned.

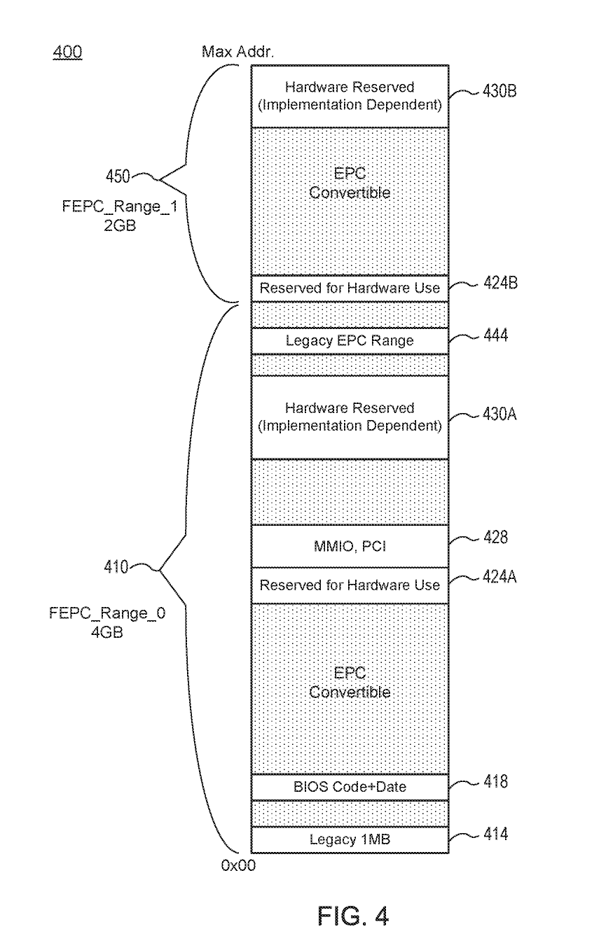

In the disclosed implementations, the first pointer 220 may point to memory addresses at which the BIOS stores sub-sets of memory ranges (of the main memory 160) that are reserved areas and thus not available for conversion to enclave pages. These sub-sets of memory ranges may be reserved for use by certain hardware or other I/O processes, for example, as will be discussed in more detail with reference to FIG. 4. The second pointer 230 may point to memory addresses at which the BIOS stores sets of memory ranges (of the main memory 160) that are delineated for conversion to enclave pages (e.g., EPC-convertible memory ranges), which is also discussed in more detail with reference to FIG. 4. These memory ranges may be delineated with a base and a mask of each FEPC range, and may be accessible by the processor core 112.

The third pointer 240 may point to memory addresses at which the processor core 112, in executing the patch-load instruction, may store a memory range reserved for code and data to be accessed by the BIOS 130. A patch-load instruction may be an instruction called by the BIOS to provide access to the PA 169 of the memory 160 by the processor core 112. This data (useable by the BIOS) may include memory protection metadata that is to be used for protected memory management and allocated upon execution of the patch-load instruction. This memory range reserved to the BIOS 130 may be treated similarly to hardware-reserved memory.

With further reference to FIGS. 1-2, the BIOS 130 may write first information and second information to the PA 169, delivering information that the processor core(s) 112 may latter access for use in activating a mode of protected memory management. The first information, for example, may delineate a memory range of the main memory allocable for flexible conversion to enclave pages. The second information may delineate sub-sets of the memory range allocated for reserved memory, e.g., memory not flexibly convertible to enclave pages. The BIOS 130 may also write other memory protection metadata for use by the processor core(s) 112 to implement a selected mode of protected memory management, as will be described in more detail.

In various implementations, the processing core 112, in executing the patch-load instruction may retrieve the memory protection metadata and the memory range of reserved memory. The processing core 112 may access a value of a bit of an architectural control register set by the OS 167 that indicates whether the OS is capable of management of flexibly-convertible enclaves of the main memory 160. The architectural control register, in one example, is IA32_SGX_CTRL where “SGX” stands for software guard extensions, which are instructions for protecting data and code stored in memory through the use of enclave pages. The processing core 112 may then activate, using the memory protection metadata and the memory range of the reserved memory, a mode of protected memory management for the processor core in response to a determination, based on the value of the bit in the architectural control register, of whether the OS is capable of management of the flexibly-convertible enclaves.

In some implementations of protected memory management, one or more processor reserved memory range register (PRMRR) may be included within any of the registers 134A and 134B, whether on die or off die of the processing core 112. The memory protection provided by the MEE 150 hardware may employ the PRMRR to designate where EPC sections and memory protection metadata are located. The flexibly-convertible enclave mode (or FEPC mode) may extend the use of the PRMRR to allow the PRMRR to be reconfigured or reprogrammed without rebooting the computer system 100. Upon being reprogrammed to support flexible EPC instruction set architecture, the PRMRR is herein renamed to flexible EPC domain range registers (FEDRR).

In various implementations, the BIOS 130 may initially program the PRMRR to support protected memory management according to a static mode. Simultaneously, the BIOS 130 may call the patch-load instruction, which starts a patch load by the processor core that allocates memory protection metadata (e.g., enclave page cache map, BEPOCH (blocked EPOCH), MEE tree, etc.) to be utilized in FEPC mode. The BIOS 130 may further store the final configuration for the FEDRR and memory map of reserved memory to hardware via the pointers stored in the PA 169. This reserved memory may include memory holes such as memory mapped I/O (MMIO) and system management random access memory (SMRAM) and the like.

The processor core 112, in executing the patch-load instruction, retrieves this memory protection metadata and memory map of reserved memory, which is made accessible to the processor core 112 to activate a mode of protected memory management as previously discussed. This memory protection metadata and memory map may also be used in execution of a write-to-model-specific-register (WRMSR) instruction to reconfigure the PRMRR, which produces a final FEDRR configuration, and to mark reserved memory as not convertible in the EPCM.

If the system software 167 is FEPC-capable, the processor core 112 may, in executing the system software 167, activate the flexibly-convertible enclave mode (FEPC) via an architectural control register (e.g., IA32_SGX_CTRL). More specifically, the processor core 112 may, upon the OS writing to the architectural control register to indicate the OS can manage flexibly-convertible enclave pages, reconfigure the PRMRR according to the FEDRR specification retrieved by access to the PA 169, to thus activate the FEPC mode. If the system software 167, however, performs a static mode of memory protection, the system software 167 may use the EPC section within the PRMRR, as previously performed in static allocation of enclave pages. Accordingly, the processor core 112 may use PRMRR for access to EPC pages in static mode. This includes finding EPCM and BEPOCH entries within the PRMRR for accessed EPC pages, as performed in the static mode. Furthermore, the processor core 112 may use the FEDRR for access control to convertible pages in FEPC mode.

Flexible EPC platforms may be configured in one of two system EPC modes, including a system static mode (e.g., static EPC mode or legacy mode) and a system flexibly-convertible enclave mode (e.g., FEPC mode). The FEPC mode can have two sub-modes: not-activated and activated. The FEPC not-activated sub-mode supports static mode operating systems, while the FEPC activated sub-mode makes available flexible EPC instruction set architecture. The FEPC not-activated sub-mode may also be referred to as unlocked EPC mode, while the FEPC activated sub-mode may be referred to as FEPC mode.

In various implementations, the processor cores 112 of multi-core processor, such as the processor 110, may operate in the same sub-mode. A FEPC sub-mode gets locked when the system software decides, either explicitly (e.g., FEPC-aware OS) or implicitly (e.g., legacy OS) how the system software wants to use enclave page capabilities. When the processor cores 112 get locked in one of the two sub-modes, no changes to the sub-mode may be allowed. An attempt to change the sub-mode after having been locked, e.g., via the IA32_SGX_CTRL model-specific register (MSR), may result in a general protection fault.

In one implementation, bits stored in a core-scoped register (e.g., CPUID.SGX_LEAF register of the registers 134A and 134B) may be set to indicate activation of a mode of protected memory management of the processor core(s) 112 as follows:
EAX.FEPC_CONFIGURED indicates whether the BIOS configured the platform in system static mode (0) or system FEPC mode (1).
EAX.FEPC_ACTIVATED indicates whether a given processor core has activated FEPC (1) or not (0).

In one implementation, bits stored in platform-scoped register (e.g., CPUID.SGX_LEAF register of the registers 134A and 134B) may be set to indicate locking into one of the above-mentioned memory protection modes:
EAX.FEPC_PLATFORM_STATS[X,Y]
XY=00: platform EPC mode not locked
XY=10: platform locked in static mode
XY=01: platform locked in FEPC mode

These registers may be employed in execution of the method 300 described with reference to FIG. 3. The computer system 100 may be locked in the static mode implicitly by a legacy OS on the first attempt to execute any enclave system function (ENCLS) leaf function. The computer system 100 may be locked in the FEPC mode explicitly by a FEPC-capable OS writing a bit in an architectural control register, e.g., the IA32_SGX_CTRL MSR. In the FEPC mode, the computer system 100 may limit access to flexible enclave pages to the cores that activated FEPC mode. Protected enclave (SGX) instructions may fault (e.g., with a general protection fault) on processor cores that do not activate FEPC mode. On the other hand, the OS is not required to activate FEPC mode on all processor cores to use enclave pages via execution of SGX instructions on the first (or subsequent) processor core that activates FEPC mode.

The computer system 100 can also be locked in the static mode explicitly by the BIOS writing to a bit in the architectural control register (e.g., the IA32_SGX_CTRL MSR). This could be done to protect legacy enclave-capable OSes from disk operating system attacks by rouge drivers that could activate FEPC mode before the legacy OS attempts to execute an ENCLS leaf function.

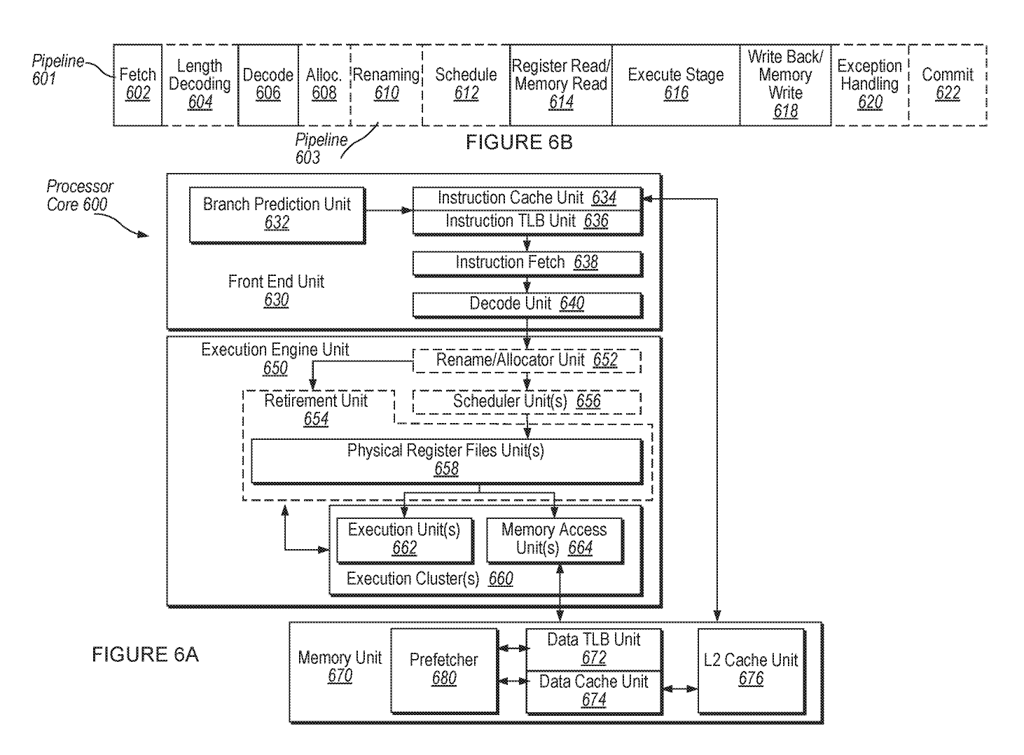

FIG. 3 is a flow chart of method 300 by which the operating system chooses a mode of protected memory management, and locks into that mode for operation, according to implementations of the disclosure. Method 300 may be performed by processing logic that may comprise hardware (e.g., circuitry, dedicated logic, programmable logic, microcode, etc.), software (such as operations being performed by the MCU), firmware or a combination thereof. In one implementation, method 300 is performed by processor 110 of FIG. 1. In another implementation, the method 300 is performed by any of the processors described with respect to FIGS. 6a-12. Alternatively, other components of the computer system 100 (or software executing on the processor 110) may perform some or all of the operations of the method 300.

Referring to FIG. 3, the method 300 begins with the processing logic (e.g., system BIOS) of the computer system 100 configuring system flexibly-convertible enclave pages, which may optionally include setting a bit for CPUID.SGX_LEAF:EAX.FEPC_CONFIGURED (310). The method 300 may continue with processing logic unlocking the mode of protected memory management of the computer system so that the system software may decide into which mode of protected memory management to enter (320). The method 300 may continue with the processing logic determining whether a first enclave system function (ENCLS) instruction has been executed (330). If yes, then the method 300 may continue with the processing logic locking the system software into a static mode, e.g., static allocation of enclave pages (335). If no, then the method 300 may continue with the processing logic determining whether an architectural control register (e.g., IA32_SGX_CTRL) has a bit set to signal to the operation system to lock into static mode (340). If yes, the method 300 may continue with the processing logic locking the system software into a static mode, e.g., static allocation of enclave pages (335). If no, the method 300 may loop back to block 320 and remain unlocked until locked into some memory management mode. If the system software locks into static mode, all the processing cores 112 so locked may need to operate in static mode, else the system software may result in a fault (like a general protection fault).

With continued reference to FIG. 3, the method may continue with processing logic of a first processor core activating flexibly-convertible enclave mode (e.g., FEPC mode) upon detecting a bit set in the architectural control register (e.g., the IA32_SGX_CTRL MSR) indicative of the system software being FEPC-capable (350). If no such detection is made, the method 300 may loop back to block 320 to check for a locking bit associated with additional processor cores 112. If yes, the bit is detected as set in the architectural control register for FEPC, the method 300 may continue with the processing logic locking the first processor core into flexible enclave pages, or FEPC, mode (360). This FEPC mode activation may occur for additional processor cores through repetition of blocks 350 and 360. Processor core(s) that did not lock into FEPC mode will not be able to execute SGX-type security instructions, and may result in a general protection fault should the system software attempt to execute such an instruction (355). The processor core(s) with activated FEPC will be able to execute SGX-type security instructions (365).

FIG. 4 is a memory diagram 400 illustrating different ranges of memory allocable for conversion to enclave pages and reserved memory that is not allocable for such conversion, according to implementations of the disclosure. The memory diagram 400 illustrates a portion of the main memory 160 according to various implementations. In FEPC mode, the BIOS 130 may set up a memory map that includes a first FEPC memory range 410, which is 4 GB large, and a second FEPC memory range 450, which is 2 GB large, so these memory ranges may vary.

According to various implementations, while the first FEPC memory range 410 may generally be convertible to enclave pages (the “EPC convertible sections), there are a number of memory reserved sections such as those discussed previously. More specifically, those memory reserved sections may include a legacy 1 MB section 414, a BIOS code and data section 418, a hardware-reserved section 424A, a memory holes section 428, and an implementation-dependent, hardware-reserved section 430A. A legacy EPC range 444 may be the statically-allocated memory range that supports static mode of enclave pages. Once the FEDRR is reprogrammed, the legacy EPC range 444 may be convertible to enclave pages.

According to various implementations, while the second FEPC memory range 450 may also be generally convertible to enclave pages, there is also hardware reserved memory. The hardware reserved memory may include a hardware-reserved section 424B and implementation-dependent, hardware-reserved section 430B. The memory sections 424A, 424B, 430A, and 430B may be reserved for hardware use and are thus not convertible to enclave pages.

When the computer system 100 is in unlocked mode or gets locked in static mode, the PRMRR may behave in accordance with static (e.g., legacy) enclave pages operation. In that case, executing of the write-to-model-specific-register (WRMSR) instruction may check for overlaps with system management range registers (SMRR) or advance programmable interrupt controller (APIC) pages, for example.

When the computer system 100 gets locked in FEPC mode, as discussed, the processing core 112 may reprogram the PRMRR according to the FEDRR configuration passed by the BIOS 130 via the predetermined area (PA) 169 of the main memory 160. As the intention is that the FEDRR covers the entire physical memory, WRMSR instructions may stop checking for overlaps with SMRR and APIC pages (which was the legacy activity of WRMSR because memory inside the SMRR area and APIC page cannot be used for enclaves).

From this point on, memory designated in the FEDRR is available to the OS (except for memory that is reserved by BIOS) and can be converted to enclave page cache (EPC) via enclave conversion instruction, EMKEPC, and back to non-EPC via non-enclave conversion instruction, EMKNONEPC, which both may be SGX instructions.

In various implementations, the processor core 112 may use a bit in the PRMRR, or some other MSR included in the registers 134A and 134B, to recognize whether the PRMRR is in static mode or in FEPC mode, and applies the appropriate access control mechanism according to the mode of enclave pages.

The BIOS 130 may create the final FEDRR configuration to cover all physical memory in the FEPC mode. Accordingly, the computer system 100 may configure several FEDRRs in order to set up memory maps of the entire physical memory. For example, it is possible that a client computer system may configure two or more FEDRRs while a server computer system may configure up to 16 FEDRRs (or more) to effectively cover all memory configurations. For example, each local socket may call for a separate FEDRR.

Although memory sizes are not always power of two, a FEDRR may be set up as per a power of two as related to memory size of the main memory 160. This means that the BIOS 130 may size FEDRRs to overlap memory holes created when a FEDRR is larger than the size of available memory. However, the patch-load instruction, once executed, may allocate enclave page metadata (EPCM) entries that cover the entire FEDRR. The BIOS 130 may pass memory hole information via the PA 169 to the patch-load mechanism so that EPCM entries that cover memory holes can be initialized to indicate that they are not convertible to enclave pages.

For example, FIG. 4 illustrates one example layout of FEDRRs on a client computer system before FEPC mode activation. When the FEPC mode is activated, FEDRR_0 may be reconfigured according to FEPC_Range_0 configuration (the first FEPC memory range 410) and FEDRR_1 according to FEPC_Range_1 (the second FEPC memory range 450). The memory in the original PRMRR_0, which corresponds to the legacy EPC range 444, becomes convertible and can be used as-is because this memory has not been accessed before FEPC mode activation, for example.

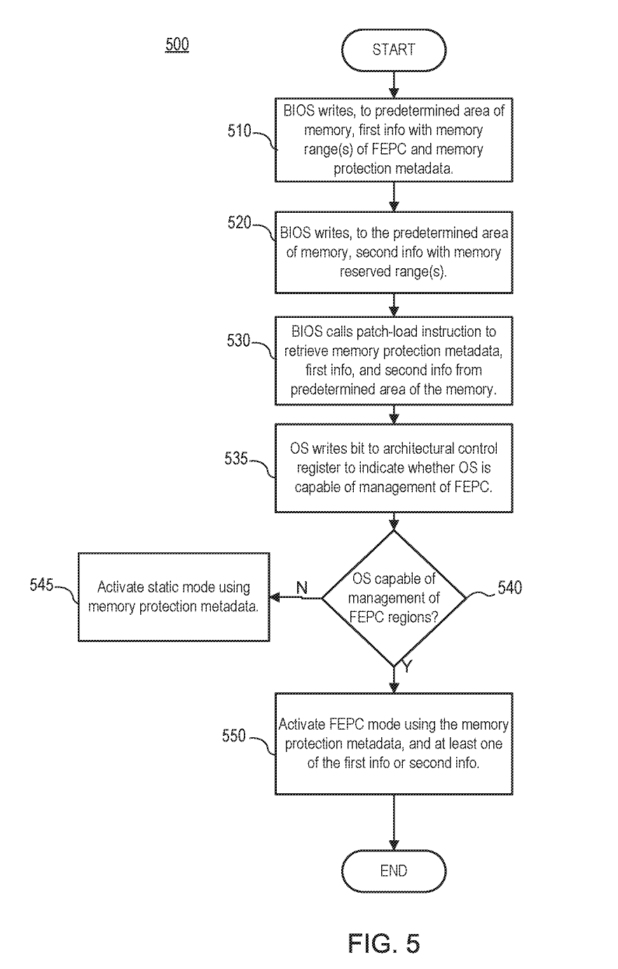

FIG. 5 is a flow chart of a method of providing hardware support for static mode and flexibly-convertible enclave mode to the operating system, without requiring a reboot, according to implementations of the disclosure. Method 500 may be performed by processing logic that may comprise hardware (e.g., circuitry, dedicated logic, programmable logic, microcode, etc.), software (such as operations being performed by the MCU), firmware or a combination thereof. In one implementation, method 500 is performed by processor 110 of FIG. 1. In another implementation, the method 500 is performed by any of the processors described with respect to FIGS. 6a-12. Alternatively, other components of the computing system 100 (or software executing on the processor 110) may perform some or all of the operations of the method 500.

Referring to FIG. 5, the method 500 begins with the processing logic of the BIOS 130 writing, to a predetermined area of memory, first information with memory protection metadata and to delineate a memory range of the main memory allocable for flexible conversion to enclave pages (FEPC) (510). The method 500 may continue with the processing logic of the BIOS 130 writing, to the predetermined area of the memory, second information to delineate sub-sets of the memory range allocated for reserved memory, wherein the reserved memory is not flexibly convertible to enclave pages (520).

With continued reference to FIG. 5, the method 500 may continue with the processing logic of the BIOS calling a patch-load instruction, which instructions initiates a patch process that retrieves the memory protection metadata, the first information, and the second information from the predetermined area of memory (530). The method 500 may continue with the OS writing a bit to an architectural control register to indicate whether the OS is capable of management of flexibly-convertible enclave pages (535). The method 500 may continue with the processing logic determining, by access to the bit in the architectural control register, whether the OS is capable of management of flexibly-convertible enclave regions (540). If the OS is not, the method 500 may continue with the processing logic activating a static mode (e.g., static allocation of enclave pages) using the memory protection metadata (545). If yes, the OS is capable, the method may continue with the processing logic activating, using the memory protection metadata and one of the first information or the second information, a mode of protected memory management in response to determining whether the operating system is capable of management of the flexibly-convertible enclave pages within the main memory (550).

FIG. 6A is a block diagram illustrating a micro-architecture for a processor 600 that implements hardware support for static mode of protected memory management on flexibly-convertible enclave platform, according to an implementation. Specifically, processor 600 depicts an in-order architecture core and a register renaming logic, out-of-order issue/execution logic to be included in a processor according to at least one implementation of the disclosure.

Processor 600 includes a front end unit 630 coupled to an execution engine unit 650, and both are coupled to a memory unit 670. The processor 600 may include a reduced instruction set computing (RISC) core, a complex instruction set computing (CISC) core, a very long instruction word (VLIW) core, or a hybrid or alternative core type. As yet another option, processor 600 may include a special-purpose core, such as, for example, a network or communication core, compression engine, graphics core, or the like. In one implementation, processor 600 may be a multi-core processor or may be part of a multi-processor system.

The front end unit 630 includes a branch prediction unit 632 coupled to an instruction cache unit 634, which is coupled to an instruction translation lookaside buffer (TLB) 636, which is coupled to an instruction fetch unit 638, which is coupled to a decode unit 640. The decode unit 640 (also known as a decoder) may decode instructions, and generate as an output one or more micro-operations, micro-code entry points, microinstructions, other instructions, or other control signals, which are decoded from, or which otherwise reflect, or are derived from, the original instructions. The decoder 640 may be implemented using various different mechanisms. Examples of suitable mechanisms include, but are not limited to, look-up tables, hardware implementations, programmable logic arrays (PLAs), microcode read only memories (ROMs), etc. The instruction cache unit 634 is further coupled to the memory unit 670. The decode unit 640 is coupled to a rename/allocator unit 652 in the execution engine unit 650.

The execution engine unit 650 includes the rename/allocator unit 652 coupled to a retirement unit 654 and a set of one or more scheduler unit(s) 656. The scheduler unit(s) 656 represents any number of different scheduler circuits, including reservations stations (RS), central instruction window, etc. The scheduler unit(s) 656 is coupled to the physical register set(s) unit(s) 658. Each of the physical register set(s) units 658 represents one or more physical register sets, different ones of which store one or more different data types, such as scalar integer, scalar floating point, packed integer, packed floating point, vector integer, vector floating point, etc., status (e.g., an instruction pointer that is the address of the next instruction to be executed), etc. The physical register set(s) unit(s) 658 is overlapped by the retirement unit 654 to illustrate various ways in which register renaming and out-of-order execution may be implemented (e.g., using a reorder buffer(s) and a retirement register set(s), using a future file(s), a history buffer(s), and a retirement register set(s); using a register maps and a pool of registers; etc.).

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 654 and the physical register set(s) unit(s) 658 are coupled to the execution cluster(s) 660. The execution cluster(s) 660 includes a set of one or more execution units 662 and a set of one or more memory access units 664. The execution units 662 may perform various operations (e.g., shifts, addition, subtraction, multiplication) and operate on various types of data (e.g., scalar floating point, packed integer, packed floating point, vector integer, vector floating point).

While some implementations may include a number of execution units dedicated to specific functions or sets of functions, other implementations may include only one execution unit or multiple execution units that all perform all functions. The scheduler unit(s) 656, physical register set(s) unit(s) 658, and execution cluster(s) 660 are shown as being possibly plural because certain implementations create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register set(s) unit, and/or execution cluster—and in the case of a separate memory access pipeline, certain implementations are implemented in which only the execution cluster of this pipeline has the memory access unit(s) 664). It should also be understood that where separate pipelines are used, one or more of these pipelines may be out-of-order issue/execution and the rest in-order.

The set of memory access units 664 is coupled to the memory unit 670, which may include a data prefetcher 680, a data TLB unit 672, a data cache unit (DCU) 674, and a level 2 (L2) cache unit 676, to name a few examples. In some implementations DCU 674 is also known as a first level data cache (L1 cache). The DCU 674 may handle multiple outstanding cache misses and continue to service incoming stores and loads. It also supports maintaining cache coherency. The data TLB unit 672 is a cache used to improve virtual address translation speed by mapping virtual and physical address spaces. In one exemplary implementation, the memory access units 664 may include a load unit, a store address unit, and a store data unit, each of which is coupled to the data TLB unit 672 in the memory unit 670. The L2 cache unit 676 may be coupled to one or more other levels of cache and eventually to a main memory.

In one implementation, the data prefetcher 680 speculatively loads/prefetches data to the DCU 674 by automatically predicting which data a program is about to consume. Prefetching may refer to transferring data stored in one memory location (e.g., position) of a memory hierarchy (e.g., lower level caches or memory) to a higher-level memory location that is closer (e.g., yields lower access latency) to the processor before the data is actually demanded by the processor. More specifically, prefetching may refer to the early retrieval of data from one of the lower level caches/memory to a data cache and/or prefetch buffer before the processor issues a demand for the specific data being returned.

The processor 600 may support one or more instructions sets (e.g., the x86 instruction set (with some extensions that have been added with newer versions); the MIPS instruction set of Imagination Technologies of Kings Langley, Hertfordshire, UK; the ARM instruction set (with optional additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated implementation of the processor also includes a separate instruction and data cache units and a shared L2 cache unit, alternative implementations may have a single internal cache for both instructions and data, such as, for example, a Level 1 (L1) internal cache, or multiple levels of internal cache. In some implementations, the system may include a combination of an internal cache and an external cache that is external to the core and/or the processor. Alternatively, all of the cache may be external to the core and/or the processor.

FIG. 6B is a block diagram illustrating an in-order pipeline and a register renaming stage, out-of-order issue/execution pipeline implemented by processor 600 of FIG. 6A according to some implementations of the disclosure. The solid lined boxes in FIG. 6B illustrate an in-order pipeline 601, while the dashed lined boxes illustrate a register renaming, out-of-order issue/execution pipeline 603. In FIG. 6B, the pipelines 601 and 603 include a fetch stage 602, a length decode stage 604, a decode stage 606, an allocation stage 608, a renaming stage 610, a scheduling (also known as a dispatch or issue) stage 612, a register read/memory read stage 614, an execute stage 616, a write back/memory write stage 618, an exception handling stage 622, and a commit stage 624. In some implementations, the ordering of stages 602-624 may be different than illustrated and are not limited to the specific ordering shown in FIG. 6B.

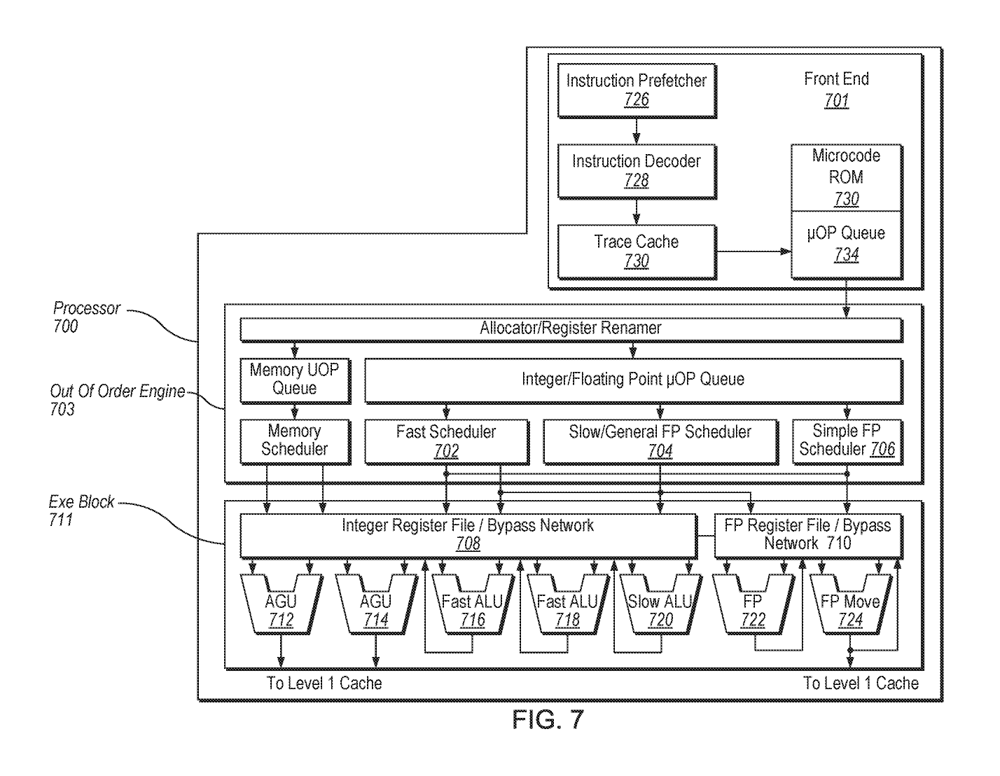

FIG. 7 illustrates a block diagram of the micro-architecture for a processor 700 that includes logic circuits of a processor or an integrated circuit that implements hardware support for static mode of protected memory management on flexibly-convertible enclave platform, according to an implementation of the disclosure. In some implementations, an instruction in accordance with one implementation can be implemented to operate on data elements having sizes of byte, word, doubleword, quadword, etc., as well as datatypes, such as single and double precision integer and floating point datatypes. In one implementation the in-order front end 701 is the part of the processor 700 that fetches instructions to be executed and prepares them to be used later in the processor pipeline. The implementations of the page additions and content copying can be implemented in processor 700.

The front end 701 may include several units. In one implementation, the instruction prefetcher 716 fetches instructions from memory and feeds them to an instruction decoder 718 which in turn decodes or interprets them. For example, in one implementation, the decoder decodes a received instruction into one or more operations called “micro-instructions” or “micro-operations” (also called micro op or uops) that the machine can execute. In other implementations, the decoder parses the instruction into an opcode and corresponding data and control fields that are used by the micro-architecture to perform operations in accordance with one implementation. In one implementation, the trace cache 730 takes decoded uops and assembles them into program ordered sequences or traces in the uop queue 734 for execution. When the trace cache 730 encounters a complex instruction, microcode ROM (or RAM) 732 provides the uops needed to complete the operation.

Some instructions are converted into a single micro-op, whereas others need several micro-ops to complete the full operation. In one implementation, if more than four micro-ops are needed to complete an instruction, the decoder 718 accesses the microcode ROM 732 to do the instruction. For one implementation, an instruction can be decoded into a small number of micro ops for processing at the instruction decoder 718. In another implementation, an instruction can be stored within the microcode ROM 732 should a number of micro-ops be needed to accomplish the operation. The trace cache 730 refers to an entry point programmable logic array (PLA) to determine a correct micro-instruction pointer for reading the micro-code sequences to complete one or more instructions in accordance with one implementation from the micro-code ROM 732. After the microcode ROM 732 finishes sequencing micro-ops for an instruction, the front end 701 of the machine resumes fetching micro-ops from the trace cache 730.

The out-of-order execution engine 703 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register set. The allocator also allocates an entry for each uop in one of the two uop queues, one for memory operations and one for non-memory operations, in front of the instruction schedulers: memory scheduler, fast scheduler 702, slow/general floating point scheduler 704, and simple floating point scheduler 706. The uop schedulers 702, 704, 706, determine when a uop is ready to execute based on the readiness of their dependent input register operand sources and the availability of the execution resources the uops need to complete their operation. The fast scheduler 702 of one implementation can schedule on each half of the main clock cycle while the other schedulers can only schedule once per main processor clock cycle. The schedulers arbitrate for the dispatch ports to schedule uops for execution.

Register sets 708, 710, sit between the schedulers 702, 704, 706, and the execution units 712, 714, 716, 718, 720, 722, 724 in the execution block 711. There is a separate register set 708, 710, for integer and floating point operations, respectively. Each register set 708, 710, of one implementation also includes a bypass network that can bypass or forward just completed results that have not yet been written into the register set to new dependent uops. The integer register set 708 and the floating point register set 710 are also capable of communicating data with the other. For one implementation, the integer register set 708 is split into two separate register sets, one register set for the low order 32 bits of data and a second register set for the high order 32 bits of data. The floating point register set 710 of one implementation has 128 bit wide entries because floating point instructions typically have operands from 64 to 128 bits in width.

The execution block 711 contains the execution units 712, 714, 716, 718, 720, 722, 724, where the instructions are actually executed. This section includes the register sets 708, 710, that store the integer and floating point data operand values that the micro-instructions need to execute. The processor 700 of one implementation is comprised of a number of execution units: address generation unit (AGU) 712, AGU 714, fast ALU 716, fast ALU 718, slow ALU 720, floating point ALU 712, floating point move unit 714. For one implementation, the floating point execution blocks 712, 714, execute floating point, MMX, SIMD, and SSE, or other operations. The floating point ALU 712 of one implementation includes a 64 bit by 64 bit floating point divider to execute divide, square root, and remainder micro-ops. For implementations of the disclosure, instructions involving a floating point value may be handled with the floating point hardware.

In one implementation, the ALU operations go to the high-speed ALU execution units 716, 718. The fast ALUs 716, 718, of one implementation can execute fast operations with an effective latency of half a clock cycle. For one implementation, most complex integer operations go to the slow ALU 720 as the slow ALU 720 includes integer execution hardware for long latency type of operations, such as a multiplier, shifts, flag logic, and branch processing. Memory load/store operations are executed by the AGUs 722, 724. For one implementation, the integer ALUs 716, 718, 720, are described in the context of performing integer operations on 64 bit data operands. In alternative implementations, the ALUs 716, 718, 720, can be implemented to support a variety of data bits including 16, 32, 128, 256, etc. Similarly, the floating point units 722, 724, can be implemented to support a range of operands having bits of various widths. For one implementation, the floating point units 722, 724, can operate on 128 bits wide packed data operands in conjunction with SIMD and multimedia instructions.

In one implementation, the uops schedulers 702, 704, 706, dispatch dependent operations before the parent load has finished executing. As uops are speculatively scheduled and executed in processor 700, the processor 700 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one implementation of a processor are also designed to catch instruction sequences for text string comparison operations.

The term “registers” may refer to the on-board processor storage locations that are used as part of instructions to identify operands. In other words, registers may be those that are usable from the outside of the processor (from a programmer's perspective). However, the registers of an implementation should not be limited in meaning to a particular type of circuit. Rather, a register of an implementation is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one implementation, integer registers store 32-bit integer data. A register set of one implementation also contains eight multimedia SIMD registers for packed data.

For the discussions herein, the registers are understood to be data registers designed to hold packed data, such as 64 bits wide MMX™ registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one implementation, in storing packed data and integer data, the registers do not need to differentiate between the two data types. In one implementation, integer and floating point are either contained in the same register set or different register sets. Furthermore, in one implementation, floating point and integer data may be stored in different registers or the same registers.

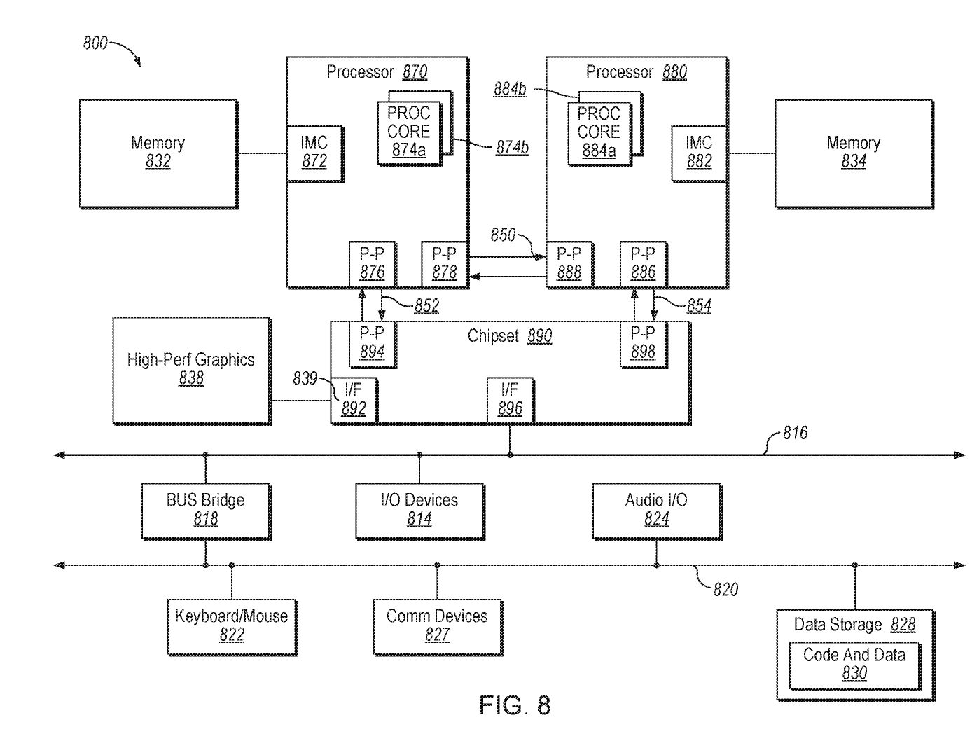

Implementations may be implemented in many different system types. Referring now to FIG. 8, shown is a block diagram of a multiprocessor system 800 in accordance with an implementation. As shown in FIG. 8, multiprocessor system 800 is a point-to-point interconnect system, and includes a first processor 870 and a second processor 880 coupled via a point-to-point interconnect 850. As shown in FIG. 8, each of processors 870 and 880 may be multicore processors, including first and second processor cores (i.e., processor cores 874a and 874b and processor cores 884a and 884b), although potentially many more cores may be present in the processors. While shown with two processors 870, 880, it is to be understood that the scope of the disclosure is not so limited. In other implementations, one or more additional processors may be present in a given processor.

Processors 870 and 880 are shown including integrated memory controller units 872 and 882, respectively. Processor 870 also includes as part of its bus controller units point-to-point (P-P) interfaces 876 and 888; similarly, second processor 880 includes P-P interfaces 886 and 888. Processors 870, 880 may exchange information via a point-to-point (P-P) interface 850 using P-P interface circuits 878, 888. As shown in FIG. 8, IMCs 872 and 882 couple the processors to respective memories, namely a memory 832 and a memory 834, which may be portions of main memory locally attached to the respective processors.

Processors 870, 880 may exchange information with a chipset 890 via individual P-P interfaces 852, 854 using point to point interface circuits 876, 894, 886, 898. Chipset 890 may also exchange information with a high-performance graphics circuit 838 via a high-performance graphics interface 839.

Chipset 890 may be coupled to a first bus 816 via an interface 896. In one implementation, first bus 816 may be a Peripheral Component Interconnect (PCI) bus, or a bus such as a PCI Express bus or interconnect bus, although the scope of the disclosure is not so limited.

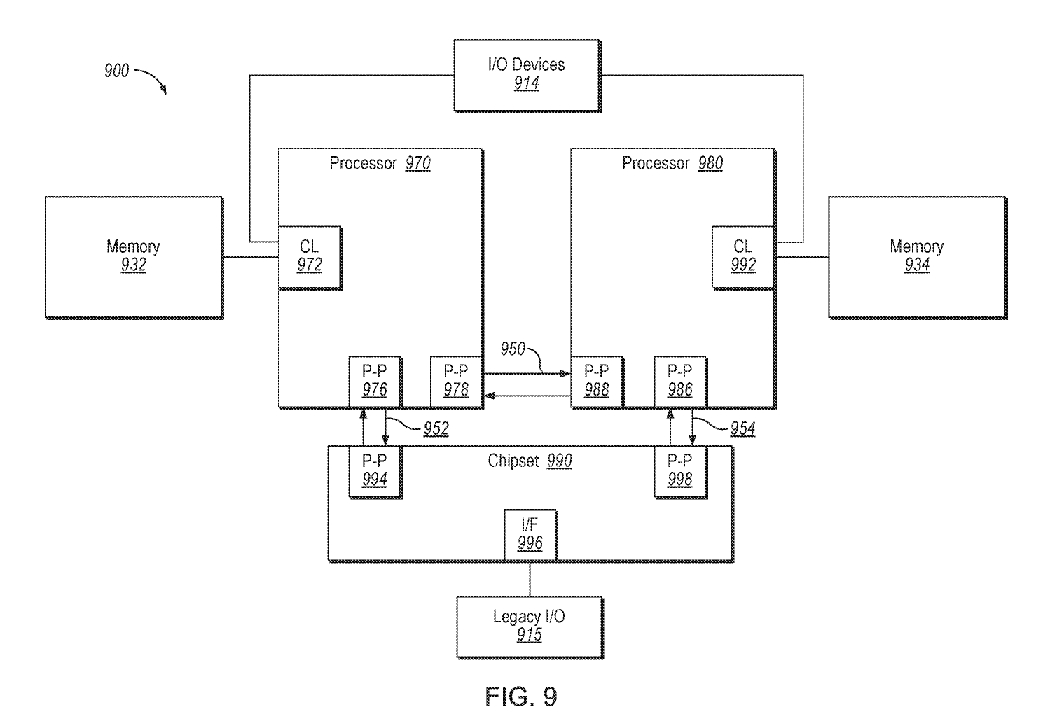

Referring now to FIG. 9, shown is a block diagram of a third system 900 in accordance with an implementation of the disclosure. Like elements in FIGS. 8 and 9 bear like reference numerals and certain aspects of FIG. 9 have been omitted from FIG. 8 in order to avoid obscuring other aspects of FIG. 9.

FIG. 9 illustrates that the processors 970, 980 may include integrated memory and I/O control logic (“CL”) 972 and 992, respectively. For at least one implementation, the CL 972, 982 may include integrated memory controller units such as described herein. In addition. CL 972, 992 may also include I/O control logic. FIG. 9 illustrates that the memories 932, 934 are coupled to the CL 972, 992, and that I/O devices 914 are also coupled to the control logic 972, 992. Legacy I/O devices 915 are coupled to the chipset 990.

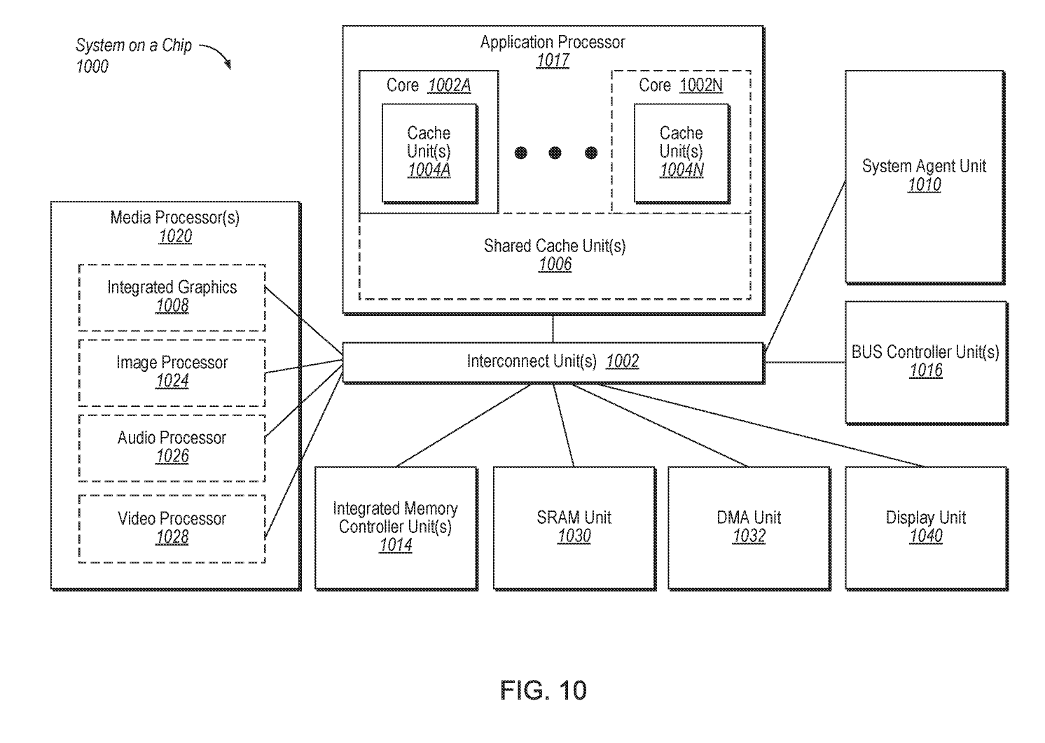

FIG. 10 is an exemplary system on a chip (SoC) 1000 that may include one or more of the cores 1002A . . . 1002N. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Within the exemplary SoC 1000 of FIG. 10, dashed lined boxes are features on more advanced SoCs. An interconnect unit(s) 1002 may be coupled to: an application processor 1017 which includes a set of one or more cores 1002A-N and shared cache unit(s) 1006; a system agent unit 1010; a bus controller unit(s) 1016; an integrated memory controller unit(s) 1014; a set of one or more media processors 1020 which may include integrated graphics logic 1008, an image processor 1024 for providing still and/or video camera functionality, an audio processor 1026 for providing hardware audio acceleration, and a video processor 1028 for providing video encode/decode acceleration; a static random access memory (SRAM) unit 1030; a direct memory access (DMA) unit 1032; and a display unit 1040 for coupling to one or more external displays.

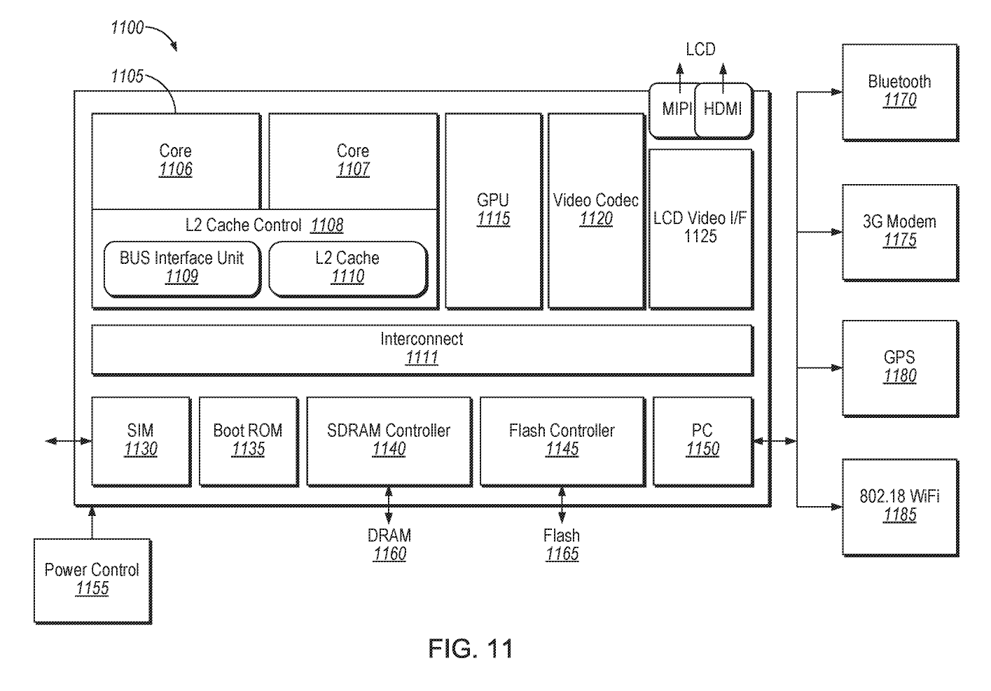

Turning next to FIG. 11, an implementation of a system on-chip (SoC) design in accordance with implementations of the disclosure is depicted. As an illustrative example, SoC 1100 is included in user equipment (UE). In one implementation, UE refers to any device to be used by an end-user to communicate, such as a hand-held phone, smartphone, tablet, ultra-thin notebook, notebook with broadband adapter, or any other similar communication device. A UE may connect to a base station or node, which can correspond in nature to a mobile station (MS) in a GSM network. The implementations of the page additions and content copying can be implemented in SoC 1100.

Here, SoC 1100 includes 2 cores—1106 and 1107. Similar to the discussion above, cores 1106 and 1107 may conform to an Instruction Set Architecture, such as a processor having the Intel® Architecture Core™, an Advanced Micro Devices, Inc. (AMD) processor, a MIPS-based processor, an ARM-based processor design, or a customer thereof, as well as their licensees or adopters. Cores 1106 and 1107 are coupled to cache control 1508 that is associated with bus interface unit 1509 and L2 cache 1510 to communicate with other parts of system 1500. Interconnect 1511 includes an on-chip interconnect, such as an IOSF, AMBA, or other interconnects discussed above, which can implement one or more aspects of the described disclosure.

In one implementation, SDRAM controller 1540 may connect to interconnect 1511 via cache 1510. Interconnect 1511 provides communication channels to the other components, such as a Subscriber Identity Module (SIM) 1130 to interface with a SIM card, a boot ROM 1135 to hold boot code for execution by cores 1106 and 1107 to initialize and boot SoC 1100, a SDRAM controller 1140 to interface with external memory (e.g. DRAM 1160), a flash controller 1145 to interface with non-volatile memory (e.g. Flash 1165), a peripheral control 1150 (e.g. Serial Peripheral Interface) to interface with peripherals, video codecs 1120 and Video interface 1125 to display and receive input (e.g. touch enabled input), GPU 1115 to perform graphics related computations, etc. Any of these interfaces may incorporate aspects of the implementations described herein.

In addition, the system illustrates peripherals for communication, such as a Bluetooth® module 1170, 3G modem 1175, GPS 1180, and Wi-Fi® 1185. Note as stated above, a UE includes a radio for communication. As a result, these peripheral communication modules may not all be included. However, in a UE some form of a radio for external communication should be included.

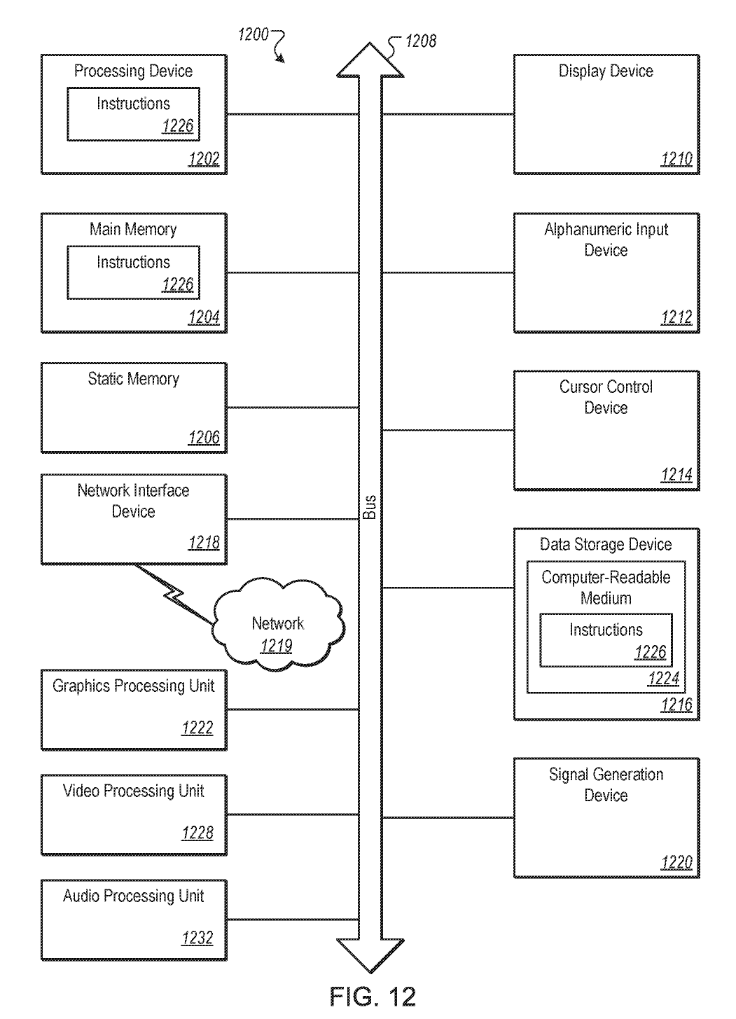

FIG. 12 illustrates a diagrammatic representation of a machine in the example form of a computing system 1200 within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. The implementations of the page additions and content copying can be implemented in computing system 1200.

The computing system 1200 includes a processing device 1202, main memory 1204 (e.g., flash memory, dynamic random access memory (DRAM) (such as synchronous DRAM (SDRAM) or DRAM (RDRAM), etc.), a static memory 1206 (e.g., flash memory, static random access memory (SRAM), etc.), and a data storage device 1216, which communicate with each other via a bus 1208.

Processing device 1202 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1202 may also be one or more special-purpose processing devices such as an application-specific integrated circuit (ASIC), a field programmable gate array (FPGA), a digital signal processor (DSP), network processor, or the like. In one implementation, processing device 1202 may include one or more processor cores. The processing device 1202 is configured to execute the processing logic 1226 for performing the operations discussed herein.

In one implementation, processing device 1202 can be part of a processor or an integrated circuit that includes the disclosed LLC caching architecture. Alternatively, the computing system 1200 can include other components as described herein. It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

The computing system 1200 may further include a network interface device 1218 communicably coupled to a network 1219. The computing system 1200 also may include a video display device 1210 (e.g., a liquid crystal display (LCD) or a cathode ray tube (CRT)), an alphanumeric input device 1212 (e.g., a keyboard), a cursor control device 1214 (e.g., a mouse), a signal generation device 1220 (e.g., a speaker), or other peripheral devices. Furthermore, computing system 1200 may include a graphics processing unit 1222, a video processing unit 1228 and an audio processing unit 1232. In another implementation, the computing system 1200 may include a chipset (not illustrated), which refers to a group of integrated circuits, or chips, that are designed to work with the processing device 1202 and controls communications between the processing device 1202 and external devices. For example, the chipset may be a set of chips on a motherboard that links the processing device 1202 to very high-speed devices, such as main memory 1204 and graphic controllers, as well as linking the processing device 1202 to lower-speed peripheral buses of peripherals, such as USB, PCI or ISA buses.

The data storage device 1216 may include a computer-readable storage medium 1224 on which is stored software 1226 embodying any one or more of the methodologies of functions described herein. The software 1226 may also reside, completely or at least partially, within the main memory 1204 as instructions 1226 and/or within the processing device 1202 as processing logic during execution thereof by the computing system 1200; the main memory 1204 and the processing device 1202 also constituting computer-readable storage media.

The computer-readable storage medium 1224 may also be used to store instructions 1226 utilizing the processing device 1202, and/or a software library containing methods that call the above applications. While the computer-readable storage medium 1224 is shown in an example implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instruction for execution by the machine and that cause the machine to perform any one or more of the methodologies of the disclosed implementations. The term “computer-readable storage medium” shall accordingly be taken to include, but not be limited to, solid-state memories, and optical and magnetic media.

The following examples pertain to further implementations.

Example 1 is processor comprising: (1) a processor core comprising a set of instructions that is to execute a basic input-output system (BIOS), wherein the processor core is to execute the set of instructions to: (a) write, to a predetermined area of main memory, first information to delineate a memory range of the main memory allocable for flexible conversion to enclave pages; and (b) write, to the predetermined area of the main memory, second information to delineate sub-sets of the memory range allocated for reserved memory, wherein the reserved memory is not flexibly convertible to enclave pages; (c) wherein the first information and the second information in the predetermined area of main memory is accessible by an operating system executable by one of the processor core or a second processor core.

In Example 2, the processor of Example 1, wherein the first information comprises a pointer to a first table, stored in the main memory, in which is listed a plurality of memory ranges that are flexibly convertible to enclave pages.

In Example 3, the processor of Example 2, wherein the second information comprises a pointer to a second table, stored in the main memory, in which is listed a plurality of reserved areas in each of at least some of the plurality of memory ranges that are delineated as reserved memory.

In Example 4, the processor of Example 1, wherein the processor core is further to execute the set of instructions to write to an architectural control register to indicate, to the operating system, a lock in a flexibly-convertible enclave mode.

In Example 5, the processor of Example 1, wherein the reserved memory comprises at least one of: hardware reserved memory; memory mapped input/output (MMIO) memory; BIOS-related memory; or system management random access memory (SMRAM).

Various implementations may have different combinations of the structural features described above. For instance, all optional features of the processors and methods described above may also be implemented with respect to a system described herein and specifics in the examples may be used anywhere in one or more implementations.

Example 6 is a system comprising: (1) a processor core and (2) a memory controller coupled between the processor core and main memory. The processor core is to (a) execute a patch-load instruction to retrieve, from a predetermined area of the main memory, memory protection metadata and a memory range of reserved memory within the main memory, wherein the reserved memory is not flexibly convertible to enclave pages; (b) access a bit an architectural control register, wherein a value of the bit is to indicate whether the operating system is capable of management of flexibly-convertible enclave pages within the main memory; and (b) activate, using the memory protection metadata and the memory range, a mode of protected memory management for the processor in response to the value of the bit in the architectural control register.

In Example 7, the system of Example 6, The system of claim 6, wherein the processor core, in execution of the operating system, is to determine that the operating system is not capable of management of the flexibly-convertible enclave pages through detection of execution of a first enclave system function.

In Example 8, the system of Example 6, wherein the processor core is further to, in response to detection of the value of the bit set within an architectural control register being indicative of capability of a static mode of protected memory management, lock management of the main memory in the static mode.

In Example 9, the system of Example 6, wherein the processor core is further to, in response to the value of the bit in the architectural control register being indicative of capability of management of the flexibly-convertible enclave pages, lock management of the main memory in a flexibly-convertible enclave mode.

In Example 10, the system of Example 9, wherein the processor core, in response to detection of the lock in the flexibly-convertible enclave mode, is further to reprogram a reserved memory range register with the memory range of the reserved memory.

In Example 11, the system of Example 9, wherein the processor core, in response to a write-to-model-specific-register instruction, is further to stop checking for overlaps with system management range registers and advance programmable interrupt controller pages within the main memory.

In Example 12, the system of Example 6, wherein the processor core is further to: (a) detect, from a bit of a model-specific register, whether a reserved memory range register is in a static mode or in a flexibly-convertible enclave mode; (b) in response to detection of the static mode, command the memory controller to allocate entries to the main memory according to static allocation of enclave pages; and (c) in response to detection of the flexibly-convertible enclave mode, command the memory controller to allocate to the main memory according to flexibly-convertible enclave pages.

In Example 13, the system of Example 6, wherein the processor core, in executing the operating system, is further to: (a) detect an attempt to change the mode of protected memory management after the mode has been locked; and (b) issue a general protection fault in response to detection of the attempt to change the mode of protected memory management.

In Example 14, the system of Example 6, wherein the predetermined area of the main memory is a first predetermined area, and wherein the processor core is further to, in response to the patch-load instruction: (a) allocate a second predetermined area of the main memory for second memory protection metadata to be generated in executing in the mode of protected memory management; and (b) write information to the first predetermined area of the main memory to delineate a memory range of the second predetermined area of the main memory, to communicate the second predetermined area of the main memory to a basic input-output system (BIOS) executable by the processor core.

Various implementations may have different combinations of the structural features described above. For instance, all optional features of the processors and methods described above may also be implemented with respect to a system described herein and specifics in the examples may be used anywhere in one or more implementations.

Example 15 is a method comprising: (a) writing to a predetermined area of main memory, via execution of a basic input-output system (BIOS) by a processor core, memory protection metadata and first information to delineate a memory range of the main memory allocable for conversion to enclave pages; (b) writing to the predetermined area of the main memory, via execution of the BIOS by the processor core, second information to delineate sub-sets of the memory range allocated for reserved memory, wherein the reserved memory is not flexibly convertible to enclave pages; (c) retrieving from the predetermined area of the main memory, by the processor core executing a patch-load instruction, the memory protection metadata, the first information, and the second information; (d) retrieving, by the processor core, a bit from an architectural control register, wherein a value of the bit is to indicate whether an operating system is capable of management of flexibly-convertible enclave pages; and (e) activating, by the processor core using the memory protection metadata and one of the first information or the second information, a mode of protected memory management for the processor core in response to the value of the bit in the architectural control register.

In Example 16, the method of Example 15, further comprising (a) determining, by the processor core executing the operating system, that the operating system is not capable of management of the flexibly-convertible enclave pages in response to detecting execution of a first enclave system function; and (b) locking memory management of the operating system in a static mode.

In Example 17, the method of Example 16, further comprising generating a general protection fault in response to detecting an attempt to change the mode of protected memory management to a flexibly-convertible enclave mode.

In Example 18, the method of Example 15, further comprising: (a) detecting, by the processor core, a flexibly-convertible enclave mode via the retrieving of the bit from the architectural control register; and (b) locking, by the processor core, memory management of the operating system in the flexibly-convertible enclave mode.

In Example 19, the method of Example 18, further comprising generating a general protection fault in response to detecting an attempt to change the mode of protected memory management to a static mode of protected memory management.

In Example 20, the method of Example 18, further comprising reprogramming, by the processor core, a reserved memory range register with the memory range and the sub-sets of the memory range in response to detecting locking in the flexibly-convertible enclave mode.

In Example 21, the method of Example 15, further comprising: (a) detecting, by the processor core from a bit of a model-specific register, whether a reserved memory range register is in a static mode or in a flexibly-convertible enclave mode; (b) in response to detecting the static mode, commanding a memory controller to allocate entries to the main memory according to static allocation of enclave pages; and (c) in response to detecting the flexibly-convertible enclave mode, commanding the memory controller to allocate to the main memory according to flexibly-convertible enclaves.

In Example 22, the method of Example 15, wherein the predetermined area of the main memory is a first predetermined area, the method further comprising: (a) allocating, by the processor core executing the patch-load instruction, a second predetermined area of the main memory for second memory protection metadata to be generated in executing in the mode of protected memory management; and (b) writing, by the processor core, information to the first predetermined area of the main memory to delineate a memory range of the second predetermined area of the main memory, to communicate the second predetermined area of the main memory to the BIOS.

Various implementations may have different combinations of the structural features described above. For instance, all optional features of the processors and methods described above may also be implemented with respect to a system described herein and specifics in the examples may be used anywhere in one or more implementations.

Example 23 is a non-transitory computer-readable medium storing instructions, which when executed by a processor having a core and a main memory, cause the processor to execute a plurality of logic operations comprising: (a) executing a patch-load instruction to retrieve, from a predetermined area of main memory, memory protection metadata and a memory range of reserved memory within the main memory, wherein the reserved memory is not flexibly convertible to enclave pages; (b) accessing a bit in an architectural control register, wherein a value of the bit is to indicate whether an operating system is capable of management of flexibly-convertible enclave pages within the main memory; and (c) activating, using the memory protection metadata and the memory range, a mode of protected memory management for the core in response to a determination, based on a value of the bit in the architectural control register, of whether the operating system is capable of management of the flexibly-convertible enclave pages.

In Example 24, the non-transitory computer-readable medium of Example 23, wherein the plurality of logic operations further comprises determining that the operating system is not capable of management of the flexibly-convertible enclave pages through detection of execution of a first enclave system function.

In Example 25, the non-transitory computer-readable medium of Example 23, wherein the plurality of logic operations further comprises locking management of the main memory in a static mode in response to detection of the value of the bit set within an architectural control register being indicative of capability of a static mode of protected memory management.

In Example 26, the non-transitory computer-readable medium of Example 23, wherein the plurality of logic operations further comprises locking management of the main memory in a flexibly-convertible enclave mode upon detection of the bit in the architectural control register being indicative of capability of management of the flexibly-convertible enclave pages.

In Example 27, the non-transitory computer-readable medium of Example 26, wherein the plurality of logic operations further comprises reprograming a reserved memory range register with the memory range of the reserved memory in response to detection of the locking in the flexibly-convertible enclave mode

In Example 28, the non-transitory computer-readable medium of Example 26, wherein the plurality of logic operations further comprises stopping to check for overlaps with system management range registers and advance programmable interrupt controller pages within the main memory, in response to executing a write-to-model-specific-register instruction.

In Example 29, the non-transitory computer-readable medium of Example 23, wherein the plurality of logic operations further comprises: (a) detecting, from a bit of a model-specific register, whether a reserved memory range register is in a static mode or in a flexibly-convertible enclave mode; (b) in response to detection of the static mode, commanding a memory controller to allocate entries to the main memory according to static allocation of enclave pages; and (c) in response to detection of the flexibly-convertible enclave mode, commanding a memory controller to allocate to the main memory according to flexibly-convertible enclave pages.

In Example 30, the non-transitory computer-readable medium of Example 23, wherein the plurality of logic operations further comprises: (a) detecting an attempt to change the mode of protected memory management after the mode has been locked; and (b) issuing a general protection fault in response to detection of the attempt to change the mode of protected memory management.

In Example 31, the non-transitory computer-readable medium of Example 23, wherein the predetermined area of the main memory is a first predetermined area, and wherein the plurality of logic operations further comprises, in response to executing the patch-load instruction: (a) allocating a second predetermined area of the main memory for second memory protection metadata to be generated in executing in the mode of protected memory management; and (b) writing information to the first predetermined area of the main memory to delineate a memory range of the second predetermined area of the main memory, to communicate the second predetermined area of the main memory to a basic input-output system (BIOS) executable by the core.

Various implementations may have different combinations of the structural features described above. For instance, all optional features of the processors and methods described above may also be implemented with respect to a system described herein and specifics in the examples may be used anywhere in one or more implementations.

Example 32 is a processor core comprising: (1) means for executing a patch-load instruction to retrieve, from a predetermined area of a main memory, memory protection metadata and a memory range of reserved memory within the main memory, wherein the reserved memory is not flexibly convertible to enclave pages; (2) means for accessing a bit in an architectural control register, wherein a value of the bit is to indicate whether an operating system is capable of management of flexibly-convertible enclave pages within the main memory; and (3) means for activating, using the memory protection metadata and the memory range, a mode of protected memory management in response to the value of the bit in the architectural control register.

In Example 33, the processor core of Example 32, further comprising means for determining that the operating system is not capable of management of the flexibly-convertible enclave pages through detection of execution of a first enclave system function.

In Example 34, the processor core of Example 32, further comprising means for, in response to the value of the bit set within an architectural control register being indicative of capability of a static mode of protected memory management, locking management of the main memory in the static mode.

In Example 35, the processor core of Example 32, further comprising means for, in response to the value of the bit in the architectural control register being indicative of capability of management of the flexibly-convertible enclave pages, locking management of the main memory in a flexibly-convertible enclave mode.

In Example 36, the processor core of Example 35, further comprising means for, in response to detection of the lock in the flexibly-convertible enclave mode, reprogramming a reserved memory range register with the memory range of the reserved memory.

In Example 37, the processor of core Example 35, further comprising means for, in response to a write-to-model-specific-register instruction, stopping to check for overlaps with system management range registers and advance programmable interrupt controller pages within the main memory.

In Example 38, the processor core of Example 32, further comprising means for: (1) detecting whether a reserved memory range register is in a static mode or in a flexibly-convertible enclave mode; (2) in response to detecting the static mode, commanding a memory controller to allocate entries to the main memory according to static allocation of enclave pages; and (3) in response to detecting the flexibly-convertible enclave mode, commanding a memory controller to allocate to the main memory according to flexibly-convertible enclave pages.

In Example 39, the processor core of Example 32, further comprising means for: (1) detecting an attempt to change the mode of protected memory management after the mode has been locked; and (2) issuing a general protection fault in response to detection of the attempt to change the mode of protected memory management.

In Example 40, the processor core of Example 32, wherein the predetermined area of the main memory is a first predetermined area, further comprising means for, in response to the patch-load instruction: (1) allocating a second predetermined area of the main memory for second memory protection metadata to be generated in executing in the mode of protected memory management; and (2) writing information to the first predetermined area of the main memory to delineate a memory range of the second predetermined area of the main memory, to communicate the second predetermined area of the main memory to a basic input-output system (BIOS).

While the disclosure has been described with respect to a limited number of implementations, those skilled in the art will appreciate numerous modifications and variations therefrom. It is intended that the appended claims cover all such modifications and variations as fall within the true spirit and scope of this disclosure.

In the description herein, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the disclosure. It will be apparent, however, to one skilled in the art that these specific details need not be employed to practice the disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of a computer system have not been described in detail in order to avoid unnecessarily obscuring the disclosure.

The implementations are described with reference to determining validity of data in cache lines of a sector-based cache in specific integrated circuits, such as in computing platforms or microprocessors. The implementations may also be applicable to other types of integrated circuits and programmable logic devices. For example, the disclosed implementations are not limited to desktop computer systems or portable computers, such as the Intel® Ultrabooks™ computers. And may be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. It is described that the system can be any kind of computer or embedded system. The disclosed implementations may especially be used for low-end devices, like wearable devices (e.g., watches), electronic implants, sensory and control infrastructure devices, controllers, supervisory control and data acquisition (SCADA) systems, or the like. Moreover, the apparatuses, methods, and systems described herein are not limited to physical computing devices, but may also relate to software optimizations for energy conservation and efficiency. As will become readily apparent in the description below, the implementations of methods, apparatuses, and systems described herein (whether in reference to hardware, firmware, software, or a combination thereof) are vital to a ‘green technology’ future balanced with performance considerations.

Although the implementations herein are described with reference to a processor, other implementations are applicable to other types of integrated circuits and logic devices. Similar techniques and teachings of implementations of the disclosure can be applied to other types of circuits or semiconductor devices that can benefit from higher pipeline throughput and improved performance. The teachings of implementations of the disclosure are applicable to any processor or machine that performs data manipulations. However, the disclosure is not limited to processors or machines that perform 512 bit, 256 bit, 128 bit, 64 bit, 32 bit, or 16 bit data operations and can be applied to any processor and machine in which manipulation or management of data is performed. In addition, the description herein provides examples, and the accompanying drawings show various examples for the purposes of illustration. However, these examples should not be construed in a limiting sense as they are merely intended to provide examples of implementations of the disclosure rather than to provide an exhaustive list of all possible implementations of implementations of the disclosure.

Although the above examples describe instruction handling and distribution in the context of execution units and logic circuits, other implementations of the disclosure can be accomplished by way of a data or instructions stored on a machine-readable, tangible medium, which when performed by a machine cause the machine to perform functions consistent with at least one implementation of the disclosure. In one implementation, functions associated with implementations of the disclosure are embodied in machine-executable instructions. The instructions can be used to cause a general-purpose or special-purpose processor that is programmed with the instructions to perform the steps of the disclosure. Implementations of the disclosure may be provided as a computer program product or software which may include a machine or computer-readable medium having stored thereon instructions which may be used to program a computer (or other electronic devices) to perform one or more operations according to implementations of the disclosure. Alternatively, operations of implementations of the disclosure might be performed by specific hardware components that contain fixed-function logic for performing the operations, or by any combination of programmed computer components and fixed-function hardware components.

Instructions used to program logic to perform implementations of the disclosure can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of implementations of the disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one implementation, refers to the hardware, which is specifically configured to recognize and/or execute the code to be held on a non-transitory medium. Furthermore, in another implementation, use of a module refers to the non-transitory medium including the code, which is specifically adapted to be executed by the microcontroller to perform predetermined operations. And as can be inferred, in yet another implementation, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one implementation, use of the term logic includes hardware, such as transistors, registers, or other hardware, such as programmable logic devices.

Use of the phrase ‘configured to,’ in one implementation, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and/or ‘operable to,’ in one implementation, refers to some apparatus, logic, hardware, and/or element designed in such a way to enable use of the apparatus, logic, hardware, and/or element in a specified manner. Note as above that use of ‘to,’ ‘capable to,’ or ‘operable to,’ in one implementation, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one implementation, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one implementation, refer to a default and an updated value or state, respectively. For example, a default value potentially includes a high logical value, i.e. reset, while an updated value potentially includes a low logical value, i.e. set. Note that any combination of values may be utilized to represent any number of states.

The implementations of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform implementations of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer)

Reference throughout this specification to “one implementation” or “an implementation” means that a particular feature, structure, or characteristic described in connection with the implementation is included in at least one implementation of the disclosure. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

In the foregoing specification, a detailed description has been given with reference to specific exemplary implementations. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of implementation and other exemplarily language does not necessarily refer to the same implementation or the same example, but may refer to different and distinct implementations, as well as potentially the same implementation.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware or a combination thereof.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “defining,” “receiving,” “determining,” “issuing,” “linking,” “associating,” “obtaining,” “authenticating,” “prohibiting,” “executing,” “requesting,” “communicating,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Also, the terms “first,” “second,” “third,” “fourth,” etc. as used herein are meant as labels to distinguish among different elements and may not necessarily have an ordinal meaning according to their numerical designation.

What is claimed is:

1. A processor comprising:
a processor core comprising a set of instructions that is to execute a basic input-output system (BIOS), wherein the processor core is to execute the set of instructions to:
write, to a predetermined area of main memory, first information to delineate a memory range of the main memory allocable for flexible conversion to enclave pages; and
write, to the predetermined area of the main memory, second information to delineate sub-sets of the memory range allocated for reserved memory, wherein the reserved memory is not flexibly convertible to enclave pages;
wherein the first information and the second information in the predetermined area of main memory is accessible by an operating system executable by one of the processor core or a second processor core.

2. The processor of claim 1, wherein the first information comprises a pointer to a first table, stored in the main memory, in which is listed a plurality of memory ranges that are flexibly convertible to enclave pages.

3. The processor of claim 2, wherein the second information comprises a pointer to a second table, stored in the main memory, in which is listed a plurality of reserved areas in each of at least some of the plurality of memory ranges that are delineated as reserved memory.

4. The processor of claim 1, wherein the processor core is further to execute the set of instructions to write to an architectural control register to indicate, to the operating system, a lock in a flexibly-convertible enclave mode.

5. The processor of claim 1, wherein the reserved memory comprises at least one of: hardware reserved memory; memory mapped input/output (MMIO) memory; BIOS-related memory; or system management random access memory (SMRAM).

6. A system comprising:
a processor core; and
a memory controller coupled between the processor core and main memory; and
wherein the processor core is to:
execute a patch-load instruction to retrieve, from a predetermined area of the main memory, memory protection metadata and a memory range of reserved memory within the main memory, wherein the reserved memory is not flexibly convertible to enclave pages;
access a bit in an architectural control register, wherein a value of the bit is to indicate whether an operating system is capable of management of flexibly-convertible enclave pages within the main memory; and
activate, using the memory protection metadata and the memory range, a mode of protected memory management for the processor core in response to the value of the bit in the architectural control register.

7. The system of claim 6, wherein the processor core, in execution of the operating system, is to determine that the operating system is not capable of management of the flexibly-convertible enclave pages through detection of execution of a first enclave system function.

8. The system of claim 6, wherein the processor core is further to, in response to the value of the bit set within an architectural control register being indicative of capability of a static mode of protected memory management, lock management of the main memory in the static mode.

9. The system of claim 6, wherein the processor core is further to, in response to the value of the bit in the architectural control register being indicative of capability of management of the flexibly-convertible enclave pages, lock management of the main memory in a flexibly-convertible enclave mode.

10. The system of claim 9, wherein the processor core, in response to detection of the lock in the flexibly-convertible enclave mode, is further to reprogram a reserved memory range register with the memory range of the reserved memory.

11. The system of claim 9, wherein the processor core, in response to a write-to-model-specific-register instruction, is further to stop checking for overlaps with system management range registers and advance programmable interrupt controller pages within the main memory.

12. The system of claim 6, wherein the processor core is further to:
detect, from a bit of a model-specific register, whether a reserved memory range register is in a static mode or in a flexibly-convertible enclave mode;
in response to detection of the static mode, command the memory controller to allocate entries to the main memory according to static allocation of enclave pages; and
in response to detection of the flexibly-convertible enclave mode, command the memory controller to allocate to the main memory according to flexibly-convertible enclave pages.

13. The system of claim 6, wherein the processor core, in executing the operating system, is further to:
detect an attempt to change the mode of protected memory management after the mode has been locked; and
issue a general protection fault in response to detection of the attempt to change the mode of protected memory management.

14. The system of claim 6, wherein the predetermined area of the main memory is a first predetermined area, and wherein the processor core is further to, in response to the patch-load instruction:
allocate a second predetermined area of the main memory for second memory protection metadata to be generated in executing in the mode of protected memory management; and
write information to the first predetermined area of the main memory to delineate a memory range of the second predetermined area of the main memory, to communicate the second predetermined area of the main memory to a basic input-output system (BIOS) executable by the processor core.

15. A method comprising:
writing to a predetermined area of main memory, via execution of a basic input-output system (BIOS) by a processor core, memory protection metadata and first information to delineate a memory range of the main memory allocable for conversion to enclave pages;
writing to the predetermined area of the main memory, via execution of the BIOS by the processor core, second information to delineate sub-sets of the memory range allocated for reserved memory, wherein the reserved memory is not flexibly convertible to enclave pages;
retrieving from the predetermined area of the main memory, by the processor core executing a patch-load instruction, the memory protection metadata, the first information, and the second information;
retrieving, by the processor core, a bit from an architectural control register, wherein a value of the bit is to indicate whether an operating system is capable of management of flexibly-convertible enclave pages; and
activating, by the processor core using the memory protection metadata and one of the first information or the second information, a mode of protected memory management for the processor core in response to the value of the bit in the architectural control register.

16. The method of claim 15, further comprising:
determining, by the processor core executing the operating system, that the operating system is not capable of management of the flexibly-convertible enclave pages in response to detecting execution of a first enclave system function; and
locking memory management of the operating system in a static mode.

17. The method of claim 16, further comprising generating a general protection fault in response to detecting an attempt to change the mode of protected memory management to a flexibly-convertible enclave mode.

18. The method of claim 15, further comprising:
detecting, by the processor core, a flexibly-convertible enclave mode via the retrieving of the bit from the architectural control register; and
locking, by the processor core, memory management of the operating system in the flexibly-convertible enclave mode.

19. The method of claim 18, further comprising generating a general protection fault in response to detecting an attempt to change the mode of protected memory management to a static mode of protected memory management.

20. The method of claim 18, further comprising reprogramming, by the processor core, a reserved memory range register with the memory range and the sub-sets of the memory range in response to detecting locking in the flexibly-convertible enclave mode.

21. The method of claim 15, further comprising:
detecting, by the processor core from a bit of a model-specific register, whether a reserved memory range register is in a static mode or in a flexibly-convertible enclave mode;
in response to detecting the static mode, commanding a memory controller to allocate entries to the main memory according to static allocation of enclave pages; and
in response to detecting the flexibly-convertible enclave mode, commanding the memory controller to allocate to the main memory according to flexibly-convertible enclaves.

22. The method of claim 15, wherein the predetermined area of the main memory is a first predetermined area, the method further comprising:
allocating, by the processor core executing the patch-load instruction, a second predetermined area of the main memory for second memory protection metadata to be generated in executing in the mode of protected memory management; and
writing, by the processor core, information to the first predetermined area of the main memory to delineate a memory range of the second predetermined area of the main memory, to communicate the second predetermined area of the main memory to the BIOS.
